(19) United States
(12) Patent Application Publication
(10) Pub. No.: US 2006/0153221 A1
(43) Pub. Date: Jul. 13, 2006

(54) Methods for IP configuration negotiation and related devices

(75) Inventor: Li-Chi Huang, Jhonghe City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Inc.

(21) Appl. No.: 11/292,627

(22) Filed: Dec. 2, 2005

(30) Foreign Application Priority Data
Dec. 23, 2004 (TW) 093140233

(51) Int. Cl. H04J 3/16

(52) U.S. Cl. 370/437

(57) ABSTRACT

Methods for IP configuration negotiation. Before terminal equipment (TE) enters a PPP mode, the TE directs a mobile terminal (MT) to perform a PDP Context Activation procedure. Then, the MT transmits a response to the TE, enabling the TE to enter PPP mode. A PPP link is then established between the TE and MT. Thereafter, the TE directs the MT to activate an IP, and the MT responds the TE according to a result of the PDP Context Activation procedure, such that the IP is activated in the TE.

### BACKGROUND

The present disclosure relates generally to wireless data service, and, more particularly, to methods for IP (Internet Protocol) configuration negotiation, and related terminal equipment (TE) and mobile terminals (MTs).

GSM (Global System for Mobile Communication) wireless data service integrates data communication and mobile communication technologies. GSM wireless data service enables acquisition of information, such as email messages, and Internet browsing without any space or regional limitations.

In GSM, a well known service is GPRS (General Packet Radio Service) which provides packet-switching data service for mobile users and enables Mobile Internet by encompassing IP. To support IP based service for mobile users, a MT usually provides an underlying protocol, such as PPP (Point-to-Point Protocol) to communicate with a TE. PPP is widely supported in numerous operating systems and alleviates the need for any specific protocol at TE. IP protocol can be encapsulated over PPP and relayed to a GPRS packet switch network (Ref. 3GPP TS 27.060).

The mechanisms for host configuration and user authentication are carried out by PPP (Ref. RFC 1661) protocol and GPRS signalingprocedure (PDP (Packet Data Protocol) Context Activation procedure Ref. 3GPP TS 23.060 and 3GP TS 24.008). FIG. 1 is a schematic diagram illustrating conventional use of IP over PPP functionality in a MT. It is noted that not all details of PPP are included, describing only logical operations of PPP connection establishment, host authentication, and IP configuration (Ref. 3GPP TS 27.060).

First, in step S101, a TE issues an AT command, such as a modem control command, to a MT to set up related parameters and enter a PPP mode. In step S102, the MT transmits an AT response to the TE. Note that block 130 represents the TE and MT in PPP mode. In step S103, PPP protocol in the TE transmits a LCP (Link Control Protocol) Configure-Request to the MT. This command establishes a PPP link between the TE and MT. In step S104, the MT returns a LCP Configure-Ack to the TE to confirm PPP link has been established. In step S105, PPP protocol in the MT transmits a LCP Configure-Request to the TE to negotiate an authentication protocol used for authentication of the host TE towards the MT. In step S106, the TE returns a LCP Configure-Ack to the MT to confirm the use of the specific authentication protocol. Then, in step S107, host authentication is executed between the TE and MT. Conventionally, since the MT must acquire related authentication data, such as username and password before a PDP Context Activation, the authentication data can be acquired during steps S103˜S106. In step S108, PPP protocol in the TE transmits a NCP (Network Control Protocol) Configure-Request to the MT. This command activates the IP protocol. If the MS is not PS (Packet Switch) attached, in step S109, the MT executes a PS attachment procedure on a GGSN (Gateway GPRS Support Node). The purpose of PS attachment is to inform a GGSN, such as a telecommunication system provider that a MT requires the GPRS service. After PS attached, in step S110, the MT performs the PDP Context Activation. IP configuration parameters may be carried between the MT and the network in the Protocol Configuration Options IE in PDP Context Activation messages. The Protocol Configuration Options IE received from the network in a PDP Context Activation Accept may contain an IP configuration response. In step S111, based on the information received in the Protocol Configuration Options IE, the MT acknowledges PPP protocol with a NCP Configure-Ack command, such that the IP protocol is activated in the TE.

Conventionally, the TE transmits an AT command to the MT to set up related parameters and enter a PPP mode (S101). In the prerequisite, before the MT receives the PDP Context Activation Accept at step S110, the TE continues to retransmit NCP Configure-Requests to the MT. Conventionally, PPP mode is used for dial-up networks, and latency is slight. This situation will finally cause PPP configuration timeout and disconnect the link between the MT and TE, or DNS (Domain Name System) cannot be configured even when NCP Configure-Ack is successfully sent by the MT to TE. The unpredicted wireless latency will result in unreliable IP configuration consequences.

### SUMMARY

Methods for IP configuration negotiation and related devices are provided.

In an exemplary embodiment of a method for IP configuration negotiation, a MT is directed to perform a PDP Context Activation procedure before a TE enters a PPP mode. Then, the MT transmits a response to the TE, enabling the TE to enter PPP mode. A PPP link between the TE and MT is established. The TE directs the MT to execute an IP configuration using a NCP request. Then, the MT responds the TE based on a result of the PDP Context Activation procedure, such that the IP protocol is activated in the TE accordingly.

If the MS is not PS attached, the MT executes a PS attachment procedure on a GGSN.

The MT and TE negotiate an authentication protocol, and an authentication procedure is executed between the TE and MT accordingly. The authentication data required is transmitted from the TE to the MT, using a short message service, or set in the MT directly.

The response is transmitted from the MT to the TE when the PDP Context Activation procedure is complete, or after a PDP Context Activation Request corresponding to the PDP Context Activation procedure is sent to a network.

Methods for IP configuration negotiation may take the form of program code embodied in tangible media. When the program code is loaded into and executed by a machine, the machine becomes an apparatus for practicing the disclosed method.

### DESCRIPTION OF THE DRAWINGS

The invention will become more fully understood by referring to the following detailed description with reference to the accompanying drawings, wherein:

FIG. 1 is a schematic diagram illustrating conventional use of IP over PPP functionality in a MT;

FIG. 2 is a schematic diagram illustrating an embodiment of a wireless environment;

FIG. 3 is a flowchart of an embodiment of a method for IP configuration negotiation;

FIG. 4 is a schematic diagram illustrating an embodiment of a storage medium storing a computer program for execution of a method for IP configuration negotiation; and

FIG. 5 is a schematic diagram illustrating another embodiment of a storage medium storing a computer program for execution of a method for IP configuration negotiation.

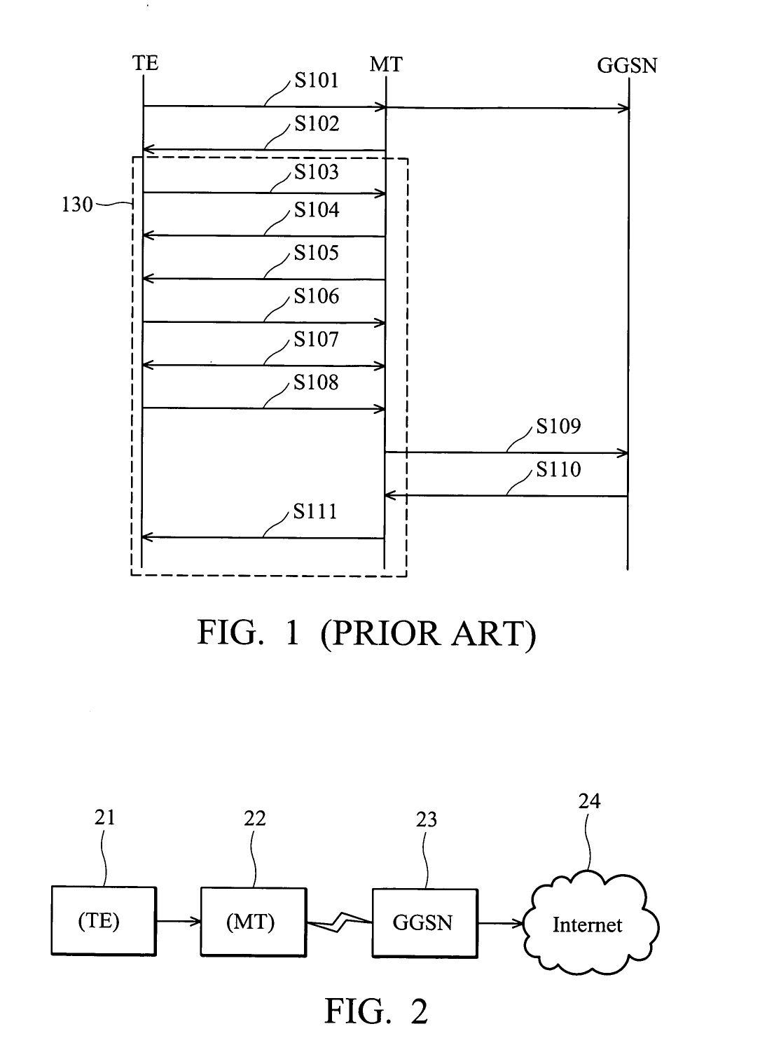

### DESCRIPTION

Methods for IP configuration negotiation and related devices are provided.

The success of IP configuration negotiation of PPP mode depends on the success of PDP Context Activation. Some embodiments of the invention enter the connection of PPP mode if the PDP Context Activation is successful, thus ensuring the success of IP configuration negotiation. In some other embodiments of the invention, the PDP Context Activation can be performed early to improve the success probability of IP configuration negotiation. In such embodiments, TE is voided to retransmit NCP Configure-Requests to MT, causing PPP configuration timeout and disconnecting the link between the MT and TE due to the unpredicted wireless latency. The invention thus ensures the success of IP configuration negotiation, improving the success probability thereof.

FIG. 2 is a schematic diagram illustrating an embodiment of a wireless environment, comprising a TE 21, such as a notebook computer, a MT 22, such as a mobile phone, and a GGSN 23, such as a telecommunication system provider and/or internet service provider. The TE21 and MT22 utilize PPP protocol to communicate with each other. The TE 21 connects to the GGSN 23 via the MT 22, and accesses Internet 24 via the GGSN 23. Before accessing Internet 24, the TE 21 and MT 22 must execute connection establishment, host authentication, IP configuration, and other related operations, as follows.

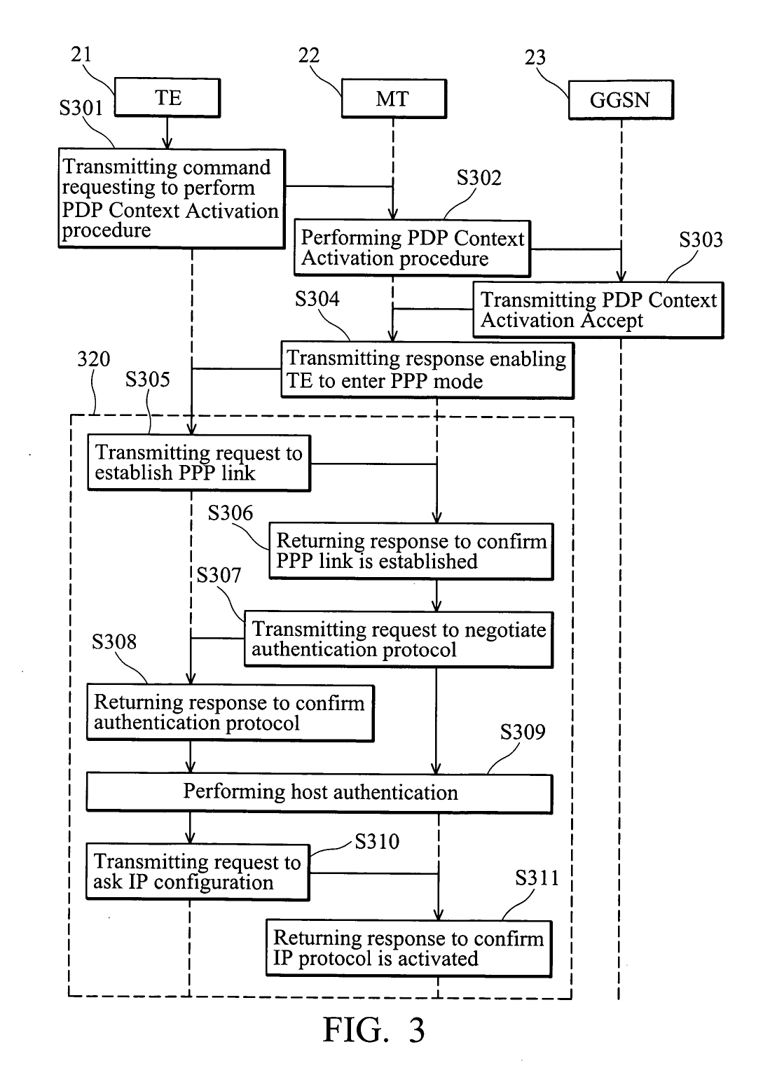

FIG. 3 is a flowchart of an embodiment of a method for IP configuration negotiation.

In step S301, the TE 21 transmits a command to the MT 22 to set up related parameters, and a request to perform a PDP Context Activation procedure. The command may be an AT command controlling modem operations. Data required for the parameters can be transmitted to the MT 22 via the command. The settings comprise requested QoS (Quality of Service) settings, PDP address (dynamic or static), APN (Access Point Name), compression setting (on or off), protocol configuration options, and others. After receiving the command from the TE 21, in step S302, the MT 22 performs the PDP Context Activation procedure on the GGSN 23 in response to the command. It is understood that IP configuration parameters may be carried between the MT 22 and the network in the Protocol Configuration Options in PDP Context Activation messages. In step S303, the GGSN 23 transmits a PDP Context Activation Accept to the MT 22 in response to the PDP Context Activation procedure. The Protocol Configuration Options IE received from the network in the PDP Context Activation Accept may contain an IP configuration response. It is understood that the IP configuration can be later used in a NCP procedure. Additionally, if the MS 22 is not PS attached, the MT 22 executes a PS attachment procedure on the GGSN 23.

In step S304, the MT 22 transmits a response to the TE 21, enabling the TE 21 to enter a PPP mode. Block 320 represents TE 21 and MT 22 in PPP mode.

In some embodiments, TE 21 entrance into PPP mode can take place after the PDP Context Activation procedure (the PDP Context Activation Accept message is received). When the PDP Context Activation is complete, the MT 22 transmits the AT response to the TE 21, such that the TE 21 enters PPP mode. In these embodiments, since the PDP Context Activation is complete, the success of PPP mode connection and IP configuration negotiation is ensured. In some embodiments, the TE 21 entrance into PPP mode may take place simultaneously with the MT 22 performing the PDP Context Activation procedure, or after a PDP Context Activation Request corresponding to the PDP Context Activation procedure is sent to a network. In other words, the MT 22 transmits the AT response to the TE 21 during PDP Context Activation. In these embodiments, PDP Context Activation takes place early to reduce the probability of PPP configuration timeout, thus improving the success probability of PPP mode connection and IP configuration negotiation. It is understood that the PDP Context Activation procedure can be performed before the NCP Configure-Request and NCP Configure-Ack requiring IP configuration. Thus, the early performance of the PDP Context Activation improves the success probability of PPP mode connection.

In step S305, PPP protocol in the TE 21 transmits a LCP Configure-Request to the MT 22 to establish a PPP link between the TE 21 and MT 22. In step S306, the MT 22 returns a LCP Configure-Ack to the TE 21 to confirm PPP link has been established.

In step S307, PPP protocol in the MT 22 transmits a LCP Configure-Request to the TE 21 to negotiate an authentication protocol for authentication between the TE 21 and the MT 22. In step S308, the TE 21 returns a LCP Configure-Ack to the MT 22 to confirm the authentication protocol. Then, in step S309, authentication is executed between the TE 21 and MT 22. It is understood that the MT 22 can initially negotiate CHAP (Challenge Handshake Authentication Protocol) for authentication, and PAP (Password Authentication Protocol) if CHAP authentication is unsuccessful. If no protocols are supported by the host TE 21, no authentication is executed. It is also understood that the necessary authentication data can be stored in the MT 22. Additionally, the TE 21 can transmit the necessary authentication data to the MT 22 via the same AT command, another AT command, a configuration setting tool, such as a connection management tool, dial-up agent, or a short message service.

In step S310, PPP protocol in the TE 21 transmits a NCP Configure-Request to the MT 22 to solicit return of IP configuration comprising an IP address and a DNS address. After receiving the NCP Configure-Request, in step S311, the MT 22 transmits the IP configuration received in step S303 to the TE 21, such that the IP protocol is activated in the TE 21. After the IP protocol is activated, the TE 21 can access the Internet 24 via the MT 22 and GGSN 23.

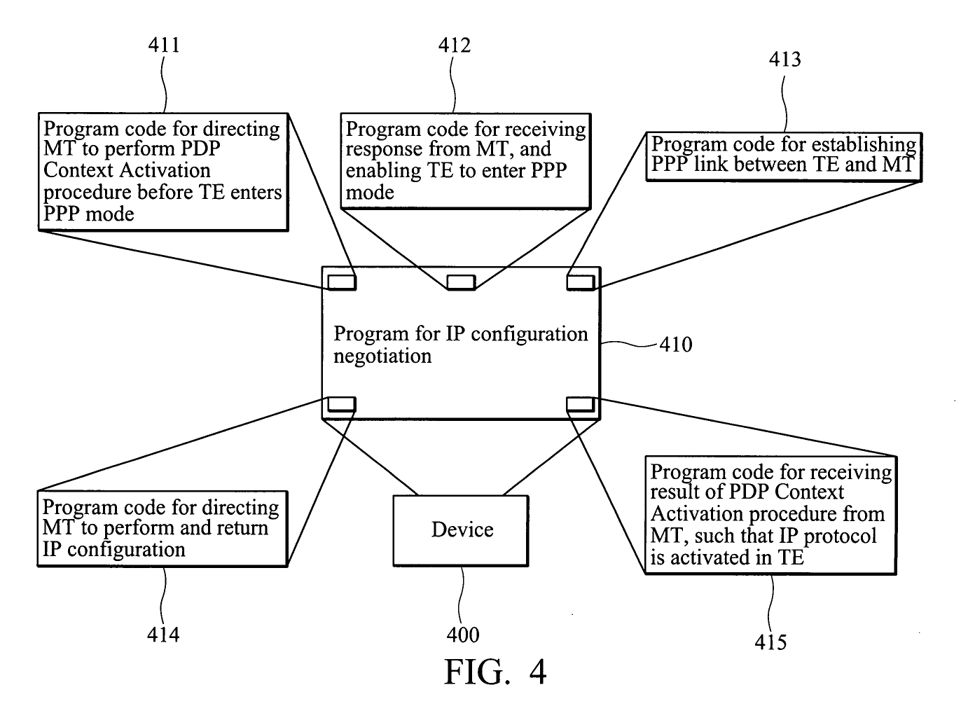

FIG. 4 is a schematic diagram illustrating an embodiment of a storage medium storing a computer program for execution of a method for IP configuration negotiation. The computer program product comprises a storage medium 410 storing computer readable program code for use in a device 400. The computer readable program code comprises at least computer readable program code 411 directing a MT to perform a PDP Context Activation procedure before a TE enters a PPP mode, computer readable program code 412 receiving a response from the MT, and enabling the TE to enter PPP mode, computer readable program code 413 establishing a PPP link between the TE and MT, computer readable program code 414 directing the MT to execute and return an IP configuration, and computer readable program code 415 receiving a result of the PDP Context Activation procedure from the MT, such that the IP protocol is activated in the TE accordingly.

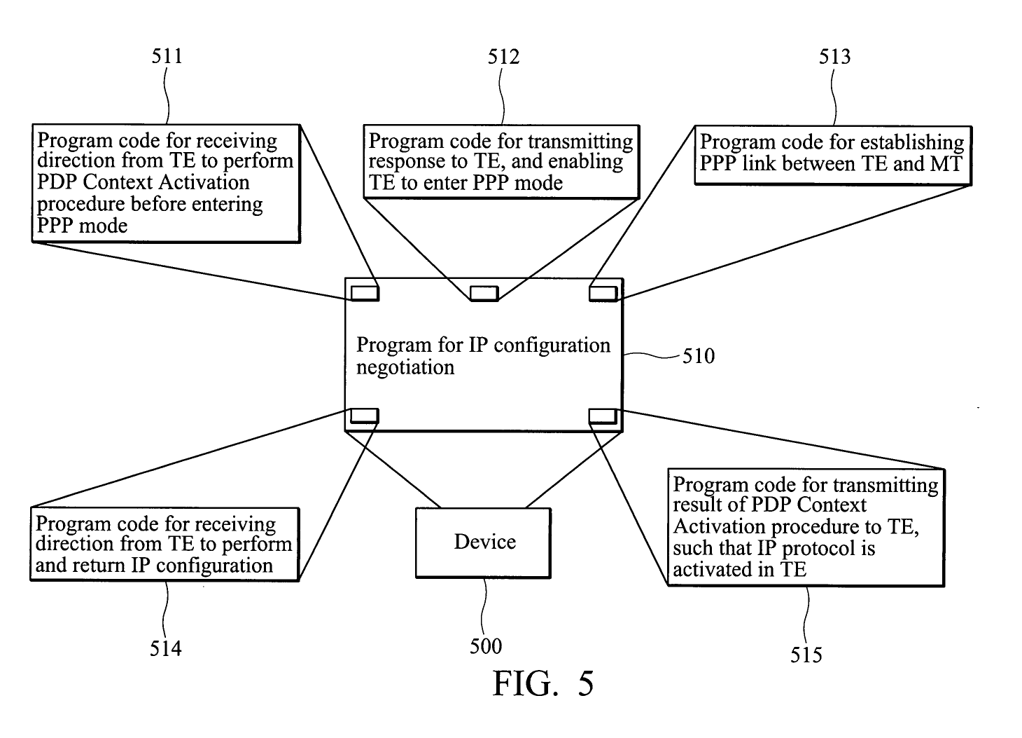

FIG. 5 is a schematic diagram illustrating another embodiment of a storage medium storing a computer program for execution of a method for IP configuration negotiation. The computer program product comprises a storage medium 510 storing computer readable program code for use in a device 500. The computer readable program code comprises at least computer readable program code 511 receiving a direction from a TE to perform a PDP Context Activation procedure before entering a PPP mode, computer readable program code 512 transmitting a response to the TE, and enabling the TE to enter PPP mode, computer readable program code 513 establishing a PPP link between the TE and MT, computer readable program code 514 receiving a direction from the TE to execute and return an IP configuration, and computer readable program code 515 transmitting a result of the PDP Context Activation procedure to the TE, such that the IP protocol is activated in the TE accordingly.

Methods for IP configuration negotiation, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A method for IP configuration negotiation, comprising:
transmitting a first command to a MT (Mobile Terminal) by a TE (Terminal Equipment) before the TE enters a PPP (Point-to-Point Protocol) mode;
performing a PDP (Packet Data Protocol) Context Activation procedure by the MT in response to the first command to obtain a PDP Context Activation Accept message, in which the PDP Context Activation Accept message comprises an IP (Internet Protocol) configuration, and the IP configuration is returned to a NCP (Network Control Protocol) Configure-Request transmitted from the TE later;
transmitting a first response corresponding to the first command to the TE by the MT, thus enabling the TE to enter PPP mode;
transmitting a first LCP (Link Control Protocol) Configure-Request to the MT by a PPP protocol in the TE, requesting a PPP link between the TE and MT;
transmitting a first LCP Configure-Ack to the TE by the MT to confirm PPP link is establish;
transmitting the NCP Configure-Request to the MT by PPP protocol in the TE, requesting the MT to execute an IP configuration; and
transmitting an IP configuration response corresponding to the IP configuration to the TE by the MT, enabling an IP protocol to be activated in the TE.

2. The method of claim 1 further comprising executing PS (Packet Switch) attachment on a GGSN (Gateway GPRS Support Node) by the MT if the MS is not PS attached.

3. The method of claim 1 further comprising:
transmitting a second LCP Configure-Request to the TE by PPP protocol in the MT, negotiating an authentication protocol;
transmitting of a second LCP Configure-Ack to the MT by the TE to confirm the authentication protocol; and
executing authentication between the TE and MT accordingly.

4. The method of claim 3 further comprising transmitting authentication data for authentication to the MT by the TE using a second command.

5. The method of claim 3 further comprising transmitting authentication data for authentication to the MT by the TE using the first command.

6. The method of claim 3 further comprising transmitting authentication data for authentication to the MT using a configuration setting tool in the TE.

7. The method of claim 3 further comprising transmitting authentication data for authentication to the MT using a short message service.

8. The method of claim 3 further comprising executing the authentication according to authentication data set in the MT.

9. The method of claim 1 wherein the first response is transmitted from the MT to the TE after the PDP Context Activation Accept message is received by the MT.

10. The method of claim 1 wherein the first response is transmitted from the MT to the TE after a PDP Context Activation Request corresponding to the PDP Context Activation procedure being sent to a network.

11. A method for negotiating an IP configuration between a TE (Terminal Equipment) and a MT (Mobile Terminal), comprising:
directing the MT to perform a PDP (Packet Data Protocol) Context Activation procedure before the TE enters a PPP (Point-to-Point Protocol) mode;
transmitting a response to the TE by the MT, thus enabling the TE to enter PPP mode;
establishing a PPP link between the TE and MT;
directing the MT to respond an IP configuration to the TE; and
responding to the TE by the MT based on a result of the PDP Context Activation procedure, such that an IP protocol is activated in the TE.

12. The method of claim 11 further comprising executing PS (Packet Switch) attachment on a GGSN (Gateway GPRS Support Node) by the MT if the MS is not PS attached.

13. The method of claim 11 further comprising:
negotiating an authentication protocol between the MT and TE; and
executing authentication accordingly.

14. The method of claim 13 further comprising transmitting authentication data for authentication to the MT by the TE.

15. The method of claim 13 further comprising transmitting authentication data for authentication to the MT using a short message service.

16. The method of claim 13 further comprising executing the authentication according to authentication data set in the MT.

17. The method of claim 11 wherein the response is transmitted from the MT to the TE when the PDP Context Activation procedure is complete.

18. The method of claim 11 wherein the response is transmitted from the MT to the TE after a PDP Context Activation Request corresponding to the PDP Context Activation procedure is sent to a network.

19. A TE (Terminal Equipment) to negotiate an IP configuration with a MT (Mobile Terminal), comprising:
a processing unit executing:
directing the MT to perform a PDP (Packet Data Protocol) Context Activation procedure before the TE enters a PPP (Point-to-Point Protocol) mode;
enabling the TE to enter PPP mode in response to a response transmitted from the MT;
establishing a PPP link between the TE and MT;
directing the MT to return an IP configuration; and
receiving a result of the PDP Context Activation procedure from the MT, such that an IP protocol is activated in the TE.

20. The TE of claim 19 wherein the processing unit further negotiates an authentication protocol with the MT.

21. The TE of claim 20 wherein the processing unit further transmits authentication data to the MT, such that authentication between the TE and MT is executed accordingly.

22. A MT (Mobile Terminal) to negotiate an IP configuration with a TE (Terminal Equipment), comprising:
a processing unit executing:
receiving a first command from the TE to perform a PDP (Packet Data Protocol) Context Activation procedure before the TE enters a PPP (Point-to-Point Protocol) mode;
transmitting a response to the TE, enabling the TE to enter PPP mode;
establishing a PPP link between the TE and MT;
receiving a second command from the TE to return an IP configuration; and
returning a result of the PDP Context Activation procedure to the TE, such that an IP protocol is activated in the TE.

23. The MT of claim 22 wherein the processing unit further executes PS (Packet Switch) attachment on a GGSN (Gateway GPRS Support Node) if the MS is not PS attached.

24. The MT of claim 22 wherein the processing unit further negotiates an authentication protocol with the TE.

25. The MT of claim 24 wherein the processing unit further receives authentication data from the TE, and executes an authentication between the TE and MT accordingly.

26. The MT of claim 24 wherein the processing unit further receives authentication data from the TE via a short message service, and executes an authentication between the TE and MT accordingly.

27. The MT of claim 24 wherein the processing unit further executes an authentication between the TE and MT according to authentication data set in the MT.

28. The MT of claim 22 wherein the processing unit transmits the response to the TE when the PDP Context Activation procedure is complete.

29. The MT of claim 22 wherein the processing unit transmits the response to the TE after a PDP Context Activation Request corresponding to the PDP Context Activation procedure is sent to a network.

30. A method for use in a TE (Terminal Equipment) to negotiate an IP configuration with a MT (Mobile Terminal), comprising:
directing the MT to perform a PDP (Packet Data Protocol) Context Activation procedure before the TE enters a PPP (Point-to-Point Protocol) mode;
enabling the TE to enter PPP mode in response to a response transmitted from the MT;
establishing a PPP link between the TE and MT;
directing the MT to respond an IP configuration; and
receiving a result of the PDP Context Activation procedure from the MT, such that an IP protocol is activated in the TE.

31. The method of claim 30 further comprising negotiating an authentication protocol with the MT.

32. The method of claim 31 further comprising transmitting authentication data to the MT, such that an authentication between the TE and MT is executed accordingly.

33. A method for use in a MT (Mobile Terminal) to negotiate an IP configuration with a TE (Terminal Equipment), comprising:
receiving a first command from the TE to perform a PDP (Packet Data Protocol) Context Activation procedure before the TE enters a PPP (Point-to-Point Protocol) mode;
transmitting a response to the TE, thus enabling the TE to enter PPP mode;
establishing a PPP link between the TE and MT;
receiving a second command from the TE to resturn an IP configuration; and
returning a result of the PDP Context Activation procedure to the TE, such that an IP protocol is activated in the TE.

34. The method of claim 33 further comprising executing PS (Packet Switch) attachment on a GGSN (Gateway GPRS Support Node) if the MS is not PS attached.

35. The method of claim 33 further comprising negotiating an authentication protocol with the TE.

36. The method of claim 35 further comprising receiving authentication data from the TE, and executes an authentication between the TE and MT accordingly.

37. The method of claim 35 further comprising receiving authentication data from the TE via a short message service, and executes an authentication between the TE and MT accordingly.

38. The method of claim 35 further comprising executing an authentication between the TE and MT according to authentication data set in the MT.

39. The method of claim 33 further comprising transmitting the response to the TE when the PDP Context Activation procedure is complete.

40. The method of claim 33 further comprising transmitting the response to the TE after a PDP Context Activation Request corresponding to the PDP Context Activation procedure being sent to a network.

41. A machine-readable storage medium comprising a computer program, which, when executed, causes a TE (Terminal Equipment) to perform a method for IP configuration negotiation, the method comprising:
directing a MT (Mobile Terminal) to perform a PDP (Packet Data Protocol) Context Activation procedure before the TE enters a PPP (Point-to-Point Protocol) mode;
enabling the TE to enter PPP mode in response to a response transmitted from the MT;
establishing a PPP link between the TE and MT;
directing the MT to return an IP configuration; and
receiving a result of the PDP Context Activation procedure from the MT, such that an IP protocol is activated in the TE.

42. A machine-readable storage medium comprising a computer program, which, when executed, causes a MT (Mobile Terminal) to perform a method for IP configuration negotiation, the method comprising:
receiving a first command from a TE (Terminal Equipment) to perform a PDP (Packet Data Protocol) Context Activation procedure before the TE enters a PPP (Point-to-Point Protocol) mode;
transmitting a response to the TE, enabling the TE to enter PPP mode;
establishing a PPP link between the TE and MT;
receiving a second command from the TE to return an IP configuration; and
returning a result of the PDP Context Activation procedure to the TE, such that an IP protocol is activated in the TE.

43. A method for IP configuration negotiation, comprising:
transmitting a first command to a MT (Mobile Terminal) by a TE (Terminal Equipment) before the TE enters a PPP (Point-to-Point Protocol) mode;
performing a PDP (Packet Data Protocol) Context Activation procedure by the MT in response to the first command to obtain a PDP Context Activation Accept message, in which the PDP Context Activation Accept message comprises an IP (Internet Protocol) configuration, and the IP configuration is returned a NCP (Network Control Protocol) Configure-Request transmitted from the TE later;
transmitting a first response corresponding to the first command to the TE by the MT after the PDP Context Activation Accept message is received by the MT, enabling the TE to enter PPP mode;
transmitting a first LCP (Link Control Protocol) Configure-Request to the MT by a PPP protocol in the TE, requesting a PPP link between the TE and MT;
transmitting a first LCP Configure-Ack to the TE by the MT to confirm PPP link is establish;
transmitting the NCP Configure-Request to the MT by PPP protocol in the TE, requesting the MT to execute an IP configuration; and
transmitting an IP configuration response corresponding to the IP configuration to the TE by the MT, enabling an IP protocol to be activated in the TE.

44. A method for IP configuration negotiation, comprising:
transmitting a first command to a MT (Mobile Terminal) by a TE (Terminal Equipment) before the TE enters a PPP (Point-to-Point Protocol) mode;
performing a PDP (Packet Data Protocol) Context Activation procedure by the MT in response to the first command to obtain a PDP Context Activation Accept message, in which the PDP Context Activation Accept message comprises an IP (Internet Protocol) configuration, and the IP configuration is returned a NCP (Network Control Protocol) Configure-Request transmitted from the TE later;
transmitting a first response corresponding to the first command to the TE by the MT during the PDP Context Activation procedure is performed, enabling the TE to enter PPP mode;
transmitting a first LCP (Link Control Protocol) Configure-Request to the MT by a PPP protocol in the TE, requesting a PPP link between the TE and MT;
transmitting a first LCP Configure-Ack to the TE by the MT to confirm PPP link is establish;
transmitting the NCP Configure-Request to the MT by PPP protocol in the TE, requesting the MT to execute an IP configuration; and
transmitting an IP configuration response corresponding to the IP configuration to the TE by the MT, enabling an IP protocol to be activated in the TE.
